(19) United States
(12) Patent Application Publication
(10) Pub. No.: US 2005/0094502 A1
(43) Pub. Date: May 5, 2005

(54) Circuit, system and method for starting up plural devices in an orderly manner

(76) Inventor: Ming-Huan Yuan, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/839,631

(22) Filed: May 4, 2004

(30) Foreign Application Priority Data
Oct. 31, 2003 (TW) 92130551

(51) Int. Cl. G11B 7/00

(52) U.S. Cl. 369/30.27

(57) ABSTRACT

A circuit for starting up plural devices in an orderly manner includes a controller (10) for controlling output of voltage signals, a plurality of switches (20), (22), (24), (26) electronically connected to the controller in parallel, and a master wire (40) electronically connected to the switches. The controller includes a plurality of pins (101), (103), (105), (107), and the switches are electronically connected to the controller by way of the pins. The plural devices are respectively connected to the switches. A related system and method for starting up plural devices in an orderly manner are also disclosed.

### BACKGROUND OF THE INVENTION

1. Field of the Invention

The present invention relates to a circuit, system and method for starting up plural electronic devices in an orderly fashion, for example when plural disk drives on a backboard need to be started up in an orderly manner.

2. Description of Related Art

Generally, a user of a computer system stores his/her data in a storage device of the system. When the data exceeds the capacity of the storage device, the user may connect plural storage devices in parallel in order to enlarge the total available capacity. The storage devices may be disk drives or any other storage devices known in the art.

Each storage device has a driving current; for example, the driving current of a typical disk drive is 2 amperes. When a power source is turned on, current from the power source drives a motor of the disk drive so that the disk drive rotates and can operate. An initial instantaneous peak-value current of the disk drive is equivalent to the driving current of 2 amperes. Thereafter, a working current of the disk drive decreases to an average value less than 2 amperes. If the user connects two disk drives in parallel, when the disk drives are driven by their respective motors simultaneously, the total instantaneous peak-value current of the disk drives is 4 amperes. When the user connects relatively few disk drives, the total instantaneous peak-value current can be easily provided by the power source. However, if the user connects numerous disk drives, the total instantaneous peak-value current is correspondingly high. For example, eight disk drives require a total instantaneous peak-value current of 16 amperes. Commonly used power sources are not able to supply such a strong current. The user may therefore employ a special power source in order to solve this problem. However, the purchase and running costs of such power source are high.

Consequently, a system and method are needed for starting up of plural devices in an orderly manner so as to decrease the instantaneous peak-value current required when the plural devices are started up.

### SUMMARY OF THE INVENTION

Accordingly, a primary object of the present invention is to provide a circuit for starting up plural devices in an orderly manner.

A second object of the present invention is to provide a system for starting up plural devices in an orderly manner.

A third object of the present invention is to provide a method for starting up plural devices in an orderly manner.

In order to fulfill the above-mentioned primary object, the present invention provides a circuit for starting up plural devices in an orderly manner. The circuit comprises a controller for controlling output of voltage signals, a plurality of switches electronically connected to the controller in parallel, and a master wire electronically connected to said switches. The controller comprises a plurality of pins, and said switches are electronically connected to the controller by way of said pins in parallel. The plural devices are respectively connected to said switches.

In order to fulfill the above-mentioned second object, the present invention provides a system for starting up plural devices in an orderly manner. The system comprises a circuit, a plurality of electronic devices, and a plurality of wires. The circuit comprises a controller for controlling output of voltage signals, a plurality of switches electronically connected to the controller in parallel, and a master wire electronically connected to said switches. The controller comprises a plurality of pins, and said switches are electronically connected to the controller by way of said pins in parallel. The wires are used for connecting the plurality of electronic devices to said switches in one-to-one correspondence.

In order to fulfill the above-mentioned third object, the present invention provides a method for starting up plural devices in an orderly manner. The method comprises the following steps: (a) outputting a low voltage to a first one of a plurality of switches to activate the first switch to an “on” status, and starting up a first one of a plurality of devices; and (b) outputting a low voltage to a subsequent one of the plurality of switches to activate the subsequent switch to an “on” status, and starting up a subsequent one of the plurality of devices; and (c) repeating step (b) if and as necessary for any further switch and any further device.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic diagram of hardware infrastructure of an exemplary embodiment of the system according to the present invention;

FIG. 2 is a schematic diagram of operation of the system of FIG. 1; and

FIG. 3 is a flow chart of an exemplary method for starting up plural devices in an orderly manner according to the present invention.

### DETAILED DESCRIPTION OF THE INVENTION

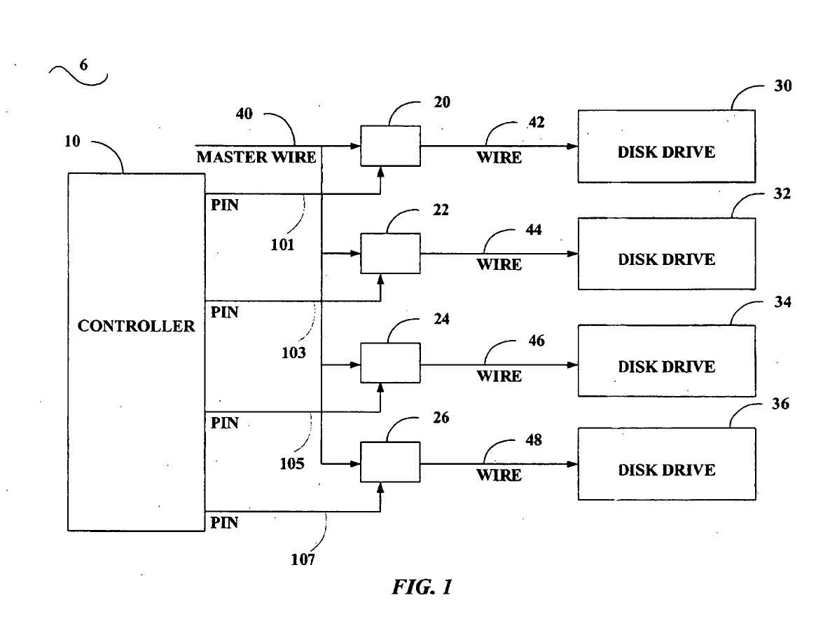

FIG. 1 is a schematic diagram of hardware infrastructure of a system 6 according to the present invention. In the exemplary embodiment of the present invention, a plurality of disk drives 30, 32, 34, 36 are provided on a backboard. The system 6 starts up the disk drives 30, 32, 34, 36 by using voltage signals. The system 6 comprises a controller 10 for controlling the output of the voltage signals, a plurality of switches 20, 22, 24, 26, a master wire 40, the disk drives 30, 32, 34, 36, and a plurality of wires 42, 44, 46, 48. The controller 10 comprises a plurality of pins 101, 103, 105, 107. Each of the switches 20, 22, 24, 26 is electronically connected to the controller 10 respectively via the pins 101, 103, 105, 107. The disk drives 30, 32, 34, 36 are electronically connected to the switches 20, 22, 24, 26 in one-to-one correspondence via the wires 42, 44, 46, 48. The switches 20, 22, 24, 26 are coupled to a power source (not shown) through the master wire 40 in parallel. The switches 20, 22, 24, 26 are provided for controlling input currents of the corresponding disk drives 30, 32, 34, 36 to which they are connected.

As described above, the system 6 of the exemplary embodiment comprises only four disk drives 30, 32, 34, 36. In other embodiments, the system 6 can comprise N disk drives (N≧2) according to a user's particular requirements. In such case, the controller 10 of the system 6 has N pins, N switches and N wires. The more disk drives there are, the longer the time needed for starting up the disk drives in an orderly sequence. Generally, the system 6 must start up all disk drives within a given time, which limits the maximum value of N. Additionally, the power source can only supply electrical power to a limited number of disk drives. That is, the power source supplying electrical power to the system 6 is also one of the factors that determines the maximum value of N. Generally, the maximum value of N in practical applications is 36.

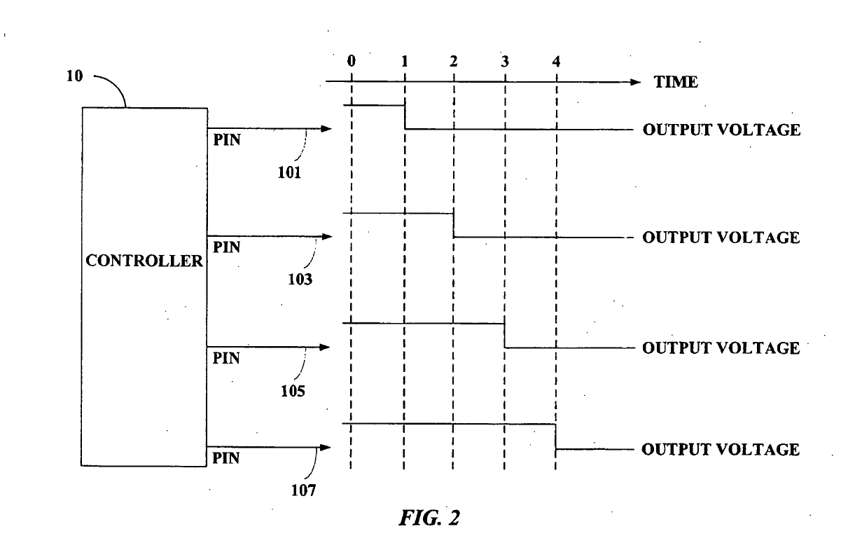

FIG. 2 is a schematic diagram of operation of the system 6 of FIG. 1. When the power source is turned on, under the control of the controller 10, high voltages are transmitted to the switches 20, 22, 24, 26 by way of the pins 101, 103, 105, 107 before a time “0.” The high voltages ensure that the switches 20, 22, 24, 26 are in an “off” status. In this state, no current is input to the disk drives 30, 32, 34, 36, which are in a “sleeping” status. When the disk drives 30, 32, 34, 36 are in the “sleeping” status, they are not able to operate.

After a first time interval has elapsed, at the time “1,” under the control of the controller 10, a low voltage is transmitted to the switch 20 by way of the pin 101, and simultaneous high voltages are transmitted to the switches 22, 24, 26 by way of the pins 103, 105, 107. The low voltage activates the switch 20 to an “on” status. The high voltages keep the switches 22, 24, 26 in an “off” status. As a result, a current from the master wire 40 is transmitted to the disk drive 30 by way of the switch 20 and the wire 42. Because of the input of the current, the disk drive 30 starts up.

After a second time interval has elapsed, at the time “2,” under the control of the controller 10, low voltages are transmitted to the switches 20, 22 respectively by way of the pins 101, 103, and simultaneous high voltages are transmitted to the switches 24, 26 by way of the pins 105, 107. The low voltages activate the switch 22 to an “on” status, and keep the switch 20 in the “on” status. The high voltages keep the switches 24, 26 in the “off” status. As a result, a current from the master wire 40 is transmitted to the disk drive 32 by way of the switch 22 and the wire 44. Because of the input of the current, the disk drive 32 starts up.

After a third time interval has elapsed, at the time “3,” under the control of the controller 10, low voltages are transmitted to the switches 20, 22, 24 respectively by way of the pins 101, 103, 105, and a simultaneous high voltage is transmitted to the switch 26 by way of the pin 107. The low voltages activate the switch 24 to an “on” status, and keep the switches 20, 22 in the “on” status. The high voltage keeps the switch 26 in the “off” status. As a result, a current from the master wire 40 is transmitted to the disk drive 34 by way of the switch 24 and the wire 46. Because of the input of the current, the disk drive 34 starts up.

After a fourth time interval has elapsed, at the time “4,” under the control of the controller 10, low voltages are transmitted to the switches 20, 22, 24, 26 respectively by way of the pins 101, 103, 105, 107. The low voltages activate the switch 26 to an “on” status, and keep the switches 20, 22, 24 in the “on” status. At that time, a current from the master wire 40 is transmitted to the disk drive 36 by way of the switch 26 and the wire 48. Because of the input of the current, the disk drive 36 starts up.

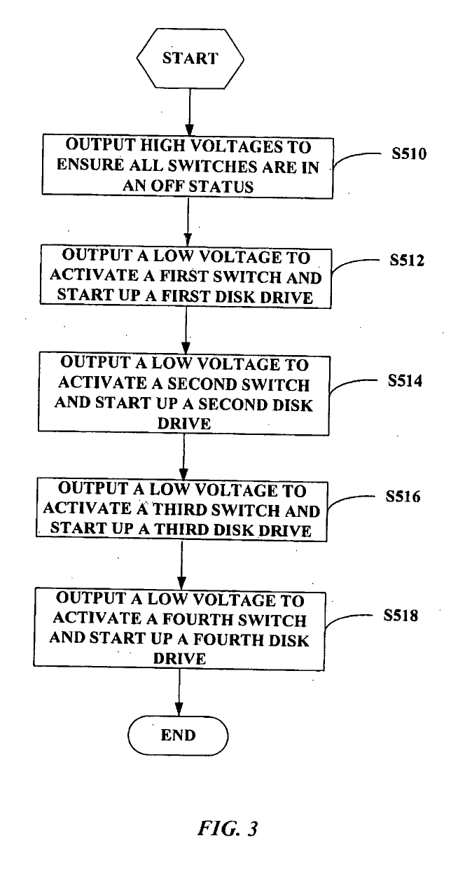

FIG. 3 is a flow chart of an exemplary method for starting up plural devices in an orderly manner according to the present invention. At step S510, the controller 10 outputs high voltages by way of the pins 101, 103, 105, 107, and the high voltages ensure that the switches 20, 22, 24, 26 are in an “off” status. At step S512, after a first time interval has elapsed, the controller 10 outputs a low voltage to the switch 20 by way of the pin 101, which activates the switch 20 to an “on” status. Then a current travels from the master wire 40 through the switch 20 and the wire 42 to the disk drive 30, which starts up the disk drive 30. At step S514, after a second time interval has elapsed, the controller 10 outputs a low voltage to the switch 22 by way of the pin 103, which activates the switch 22 to an “on” status. Then a current travels from the master wire 40 through the switch 22 and the wire 44 to the disk drive 32, which starts up the disk drive 32. At step S516, after a third time interval has elapsed, the controller 10 outputs a low voltage to the switch 24 by way of the pin 105, which activates the switch 24 to an “on” status. Then a current travels from the master wire 40 through the switch 24 and the wire 46 to the disk drive 34, which starts up the disk drive 34. At step S518, after a fourth time interval has elapsed, the controller 10 outputs a low voltage to the switch 26 by way of the pin 107, which activates the switch 26 to an “on” status. Then a current travels from the master wire 40 through the switch 26 and the wire 48 to the disk drive 36, which starts up the disk drive 36.

While a preferred embodiment and preferred method of the present invention have been described above, it should be understood that they have been presented by way of example only and not by way of limitation. Thus the breadth and scope of the present invention should not be limited by the above-described exemplary embodiment and method, but should be defined only in accordance with the following claims and their equivalents.

1. A circuit for starting up plural devices in an orderly manner, the circuit comprising:
a controller for controlling output of voltage signals;
a plurality of switches electronically connected to the controller in parallel; and
a master wire electronically connected to said switches;
whereby the plural devices are respectively connected to said switches.

2. The circuit as claimed in claim 1, wherein the controller comprises a plurality of pins, and said switches are electronically connected to the controller by way of said pins.

3. The circuit as claimed in claim 1, wherein the controller outputs high voltages for ensuring said switches are in an “off” status.

4. The circuit as claimed in claim 3, wherein after a first time interval has elapsed, the controller outputs a low voltage to a first one of said switches to activate the first switch to an “on” status.

5. The circuit as claimed in claim 4, wherein after a second time interval has elapsed, the controller outputs a low voltage to a second one of said switches to activate the second switch to an “on” status.

6. An electrical system for starting up plural devices in an orderly manner, the electrical system comprising:
a circuit comprising:
a controller for controlling output of voltage signals;
a plurality of switches electronically connected to the controller in parallel; and
a master wire electronically connected to said switches;
a plurality of electronic devices; and
a plurality of wires connecting said devices to said switches in one-to-one correspondence.

7. The electrical system as claimed in claim 6, wherein said devices are disk drives on a backboard.

8. The electrical system as claimed in claim 6, wherein the controller comprises a plurality of pins, and the switches are electronically connected to the controller by way of said pins.

9. The electrical system as claimed in claim 6, wherein the controller outputs high voltages for ensuring the switches are in an “off” status.

10. The electrical system as claimed in claim 9, wherein after a first time interval has elapsed, the controller outputs a low voltage to a first one of the switches to activate the first switch to an “on” status, and a current from the master wire starts up a first one of said devices.

11. The electrical system as claimed in claim 10, wherein after a second time interval has elapsed, the controller outputs a low voltage to a second one of switches to activate the second switch to an “on” status, and a current from the master wire starts up a second one of said devices.

12. A method for starting up plural electronic devices in an orderly manner, the method comprising the following steps:
(a) outputting a low voltage to a first one of a plurality of switches to activate the first switch to an “on” status, and starting up a first one of the devices;
(b) outputting a low voltage to a subsequent one of the plurality of switches to activate the subsequent switch to an “on” status, and starting up a subsequent one of the devices and
(c) repeating step (b) if and as necessary for any further switch and any further device.

13. The method as claimed in claim 12, further comprising before step (a) the step of outputting high voltages for ensuring that the plurality of switches are in an “off” status.

14. The method as claimed in claim 12. wherein each of said switches is respectively connected to a controller, a corresponding master wire, and one of said electronic devices via a subordinate wire.
